(19) United States
(12) Patent Application Publication
(10) Pub. No.: US 2026/0191132 A1
(43) Pub. Date: Jul. 9, 2026

(54) ROBOT AND GRASS MOWING AND COLLECTING DEVICE

(71) Applicant: SUZHOU LAIMOU TECHNOLOGY CO., LTD., Suzhou, Jiangsu (CN)

(72) Inventors: Wangshu GAO, Beijing (CN); Yongmin LI, Beijing (CN); Teng FENG, Beijing (CN); Dawei WANG, Beijing (CN)

(73) Assignee: SUZHOU LAIMOU TECHNOLOGY CO., LTD., Suzhou, Jiangsu (CN)

(21) Appl. No.: 19/130,651

(22) PCT Filed: Nov. 13, 2023
(86) PCT No.: PCT/CN2023/131357

§ 371 Date: May 16, 2025

(30) Foreign Application Priority Data
Nov. 16, 2022 (CN) 202223050481.6

(51) Int. Cl. A01D 34/40; A01D 34/04; A01D 43/06; A01D 101/00

(52) U.S. Cl. CPC A01D 34/40; A01D 34/04; A01D 43/06; A01D 2101/00

(57) ABSTRACT

A mowing robot and a grass mowing and collecting device are provided. The mowing robot includes a body, a movement mechanism, a cutter assembly, a detection sensor, and an autonomous navigation module. The movement mechanism is connected to the body and configured to drive the body to move, the movement mechanism is a crawler track mechanism. The cutter assembly is arranged in front of the body and includes a blade. The detection sensor is configured to detect an environment in which the mowing robot is located and obtain detection data. The autonomous navigation module is configured to plan a traveling path of the mowing robot according to the detection data.

The present application claims priority to Chinese Patent Application No. 202223050481.6, filed on Nov. 16, 2022, which is incorporated herein by reference in its entirety as a part of the present application.

### TECHNICAL FIELD

Embodiments of the present disclosure relate to a mowing robot and a grass mowing and collecting device.

### BACKGROUND

A lawn mower used in landscaping is gradually developing in a direction of automatic control to reduce labor costs. At present, the movement mechanism of the lawn mower on the market usually adopts wheels, which are difficult to cope with rough roads. Moreover, a cutter of the lawn mower is often arranged below the lawn mower and exposed outside, so that it is often difficult to cut grass at corners in a process of mowing grass. Furthermore, if people, animals and other obstacles are encountered, the cutter cannot be effectively stopped, which has a serious potential safety hazard. On the one hand, the cutter itself is prone to problems such as jamming, winding and bumping, which affects the normal use and the service life of the cutter. On the other hand, the lawn mower on the market often lacks the functions of shredding grass and recycling grass, so that the cut grass cannot be effectively treated.

### SUMMARY

At least one embodiment of the present disclosure provides a mowing robot and a grass mowing and collecting device, which can solve the problems that it is difficult to deal with rough roads, it is impossible to mow grass in all directions, the cutter has a potential safety hazard, and it is impossible to achieve the functions of shredding grass and recycling grass.

At least one embodiment of the present disclosure provides a mowing robot, the mowing robot

### BRIEF DESCRIPTION OF DRAWINGS

In order to clearly illustrate technical solutions of the embodiments of the present disclosure, the drawings of the embodiments will be briefly described. It is obvious that the described drawings in the following are only related to some embodiments of the present disclosure and thus are not construed as any limitation to the present disclosure.

FIG. 1 is a schematic diagram of a three-dimensional structure of a mowing robot according to at least one embodiment of the present disclosure;

FIG. 2 is another schematic diagram of a three-dimensional structure of a mowing robot according to at least one embodiment of the present disclosure;

FIG. 3 is a schematic diagram of a cross-sectional structure of a mowing robot according to at least one embodiment of the present disclosure;

FIG. 4 is another schematic diagram of a cross-sectional structure of a mowing robot according to at least one embodiment of the present disclosure;

FIG. 5 is a schematic diagram of a side structure of a mowing robot according to at least one embodiment of the present disclosure;

FIG. 6 is a schematic diagram of a front structure of a mowing robot according to at least one embodiment of the present disclosure;

FIG. 7 is a schematic diagram of a back structure of a mowing robot according to at least one embodiment of the present disclosure;

FIG. 8 is a schematic diagram of a top structure of a mowing robot according to at least one embodiment of the present disclosure;

FIG. 9 is a schematic diagram of a bottom structure of a mowing robot according to at least one embodiment of the present disclosure;

FIG. 10 is another schematic diagram of a cross-sectional structure of a mowing robot according to at least one embodiment of the present disclosure;

FIG. 11 is a schematic diagram of a cross-sectional structure of another mowing robot according to at least one embodiment of the present disclosure;

FIG. 12 is a schematic diagram of another cross-sectional structure of another mowing robot according to at least one embodiment of the present disclosure;

FIG. 13 is a schematic diagram of a rear structure of another mowing robot according to at least one embodiment of the present disclosure;

FIG. 14 is a schematic diagram of a three-dimensional structure of a grass mowing and collecting device according to at least one embodiment of the present disclosure;

FIG. 15 is a schematic diagram of a side structure of a grass mowing and collecting device according to at least one embodiment of the present disclosure;

FIG. 16 is a schematic diagram of a top structure of a grass mowing and collecting device according to at least one embodiment of the present disclosure;

FIG. 17 is a schematic diagram of a side structure of a grass mowing and collecting device, in an initial state, according to at least one embodiment of the present disclosure;

FIG. 18 is a schematic diagram of a three-dimensional structure of a grass mowing and collecting device, in an initial state, according to at least one embodiment of the present disclosure;

FIG. 19 is a schematic diagram of a side structure of a grass mowing and collecting device, in an overturned state, according to at least one embodiment of the present disclosure; and

FIG. 20 is a schematic diagram of a three-dimensional structure of a grass mowing and collecting device, in an overturned state, according to at least one embodiment of the present disclosure.

### DETAILED DESCRIPTION

In order to make objectives, technical details, and advantages of the embodiments of the present disclosure clearer, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first”, “second”, etc., which are used in the present disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “left,” “right” and the like are only used to indicate relative position relationship, and when the position of the object which is described is changed, the relative position relationship may be changed accordingly.

As mentioned above, for a mowing robot on the market at present, it is difficult to deal with rough roads, it is impossible to mow grass in all directions, the cutter has a potential safety hazard, and it is impossible to achieve the functions of shredding grass and recycling grass.

At least one embodiment of the present disclosure provides a mowing robot. The mowing robot includes a body, a movement mechanism, a cutter assembly, a detection sensor, and an autonomous navigation module. The movement mechanism is connected to the body and configured to drive the body to move, the movement mechanism is a crawler track mechanism. The cutter assembly is arranged in front of the body and includes at least two layers of blades arranged in a stacked manner and a driving mechanism for driving the at least two layers of blades, the driving mechanism is configured to drive the at least two layers of blades to perform reciprocating relative movement to cut grass. The detection sensor is configured to detect an environment in which the mowing robot is located and obtain detection data. The autonomous navigation module is configured to plan a traveling path of the mowing robot according to the detection data.

At least one embodiment of the present disclosure provides a grass mowing and collecting device. The grass mowing and collecting device includes the mowing robot according to the embodiments of the present disclosure and a grass storage box. The mowing robot includes a grass collecting apparatus. The grass storage box includes a grass inlet, the grass inlet is configured to be connected to a grass outlet of the grass collecting apparatus to receive the grass in the grass collecting apparatus.

The mowing robot according to the embodiments of the present disclosure uses a crawler track mechanism, which can better cope with rough roads. The cutter of the mowing robot is arranged in front of the body, which can cut the grass at corners to mow grass in all directions. On the one hand, the cutter is equipped with a protective apparatus, thereby improving safety of the cutter, achieving protection of the cutter and prolonging the service life of the cutter. On the other hand, the mowing robot is provided with an autonomous navigation module, which can achieve automatic mowing. The grass mowing and collecting device according to the embodiments of the present disclosure can collect/recycle the grass cut by the mowing robot, thereby achieving an automatic grass collecting/recycling function.

The mowing robot and the grass mowing and collecting device according to the embodiments of the present disclosure will be described below through several specific embodiments.

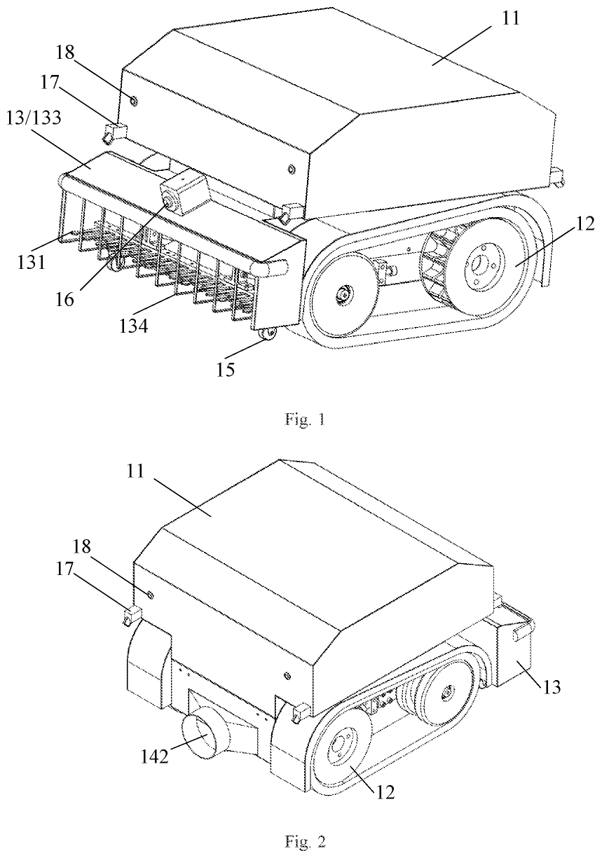

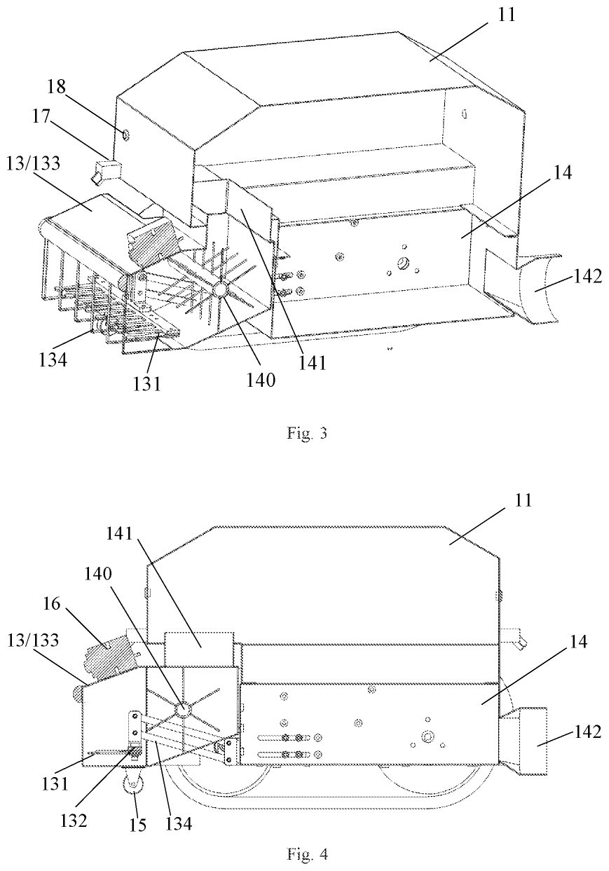

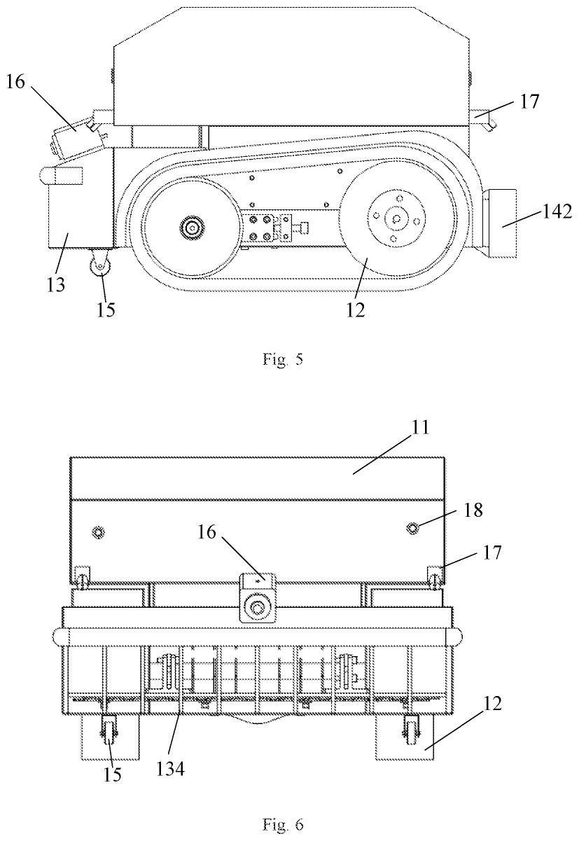

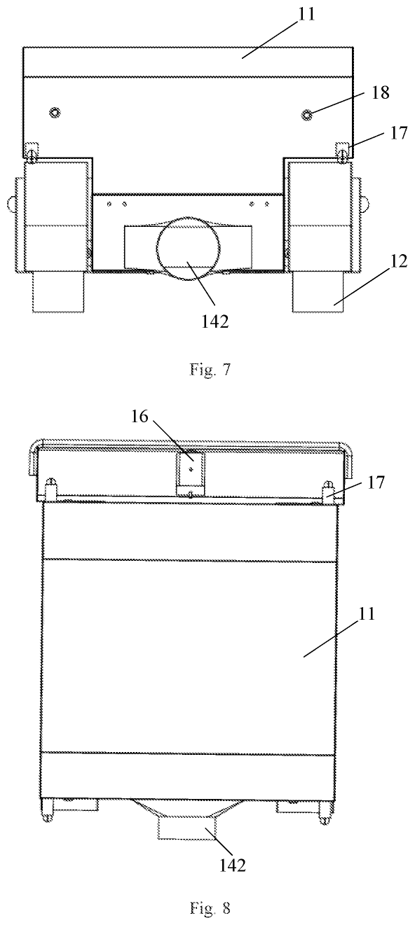

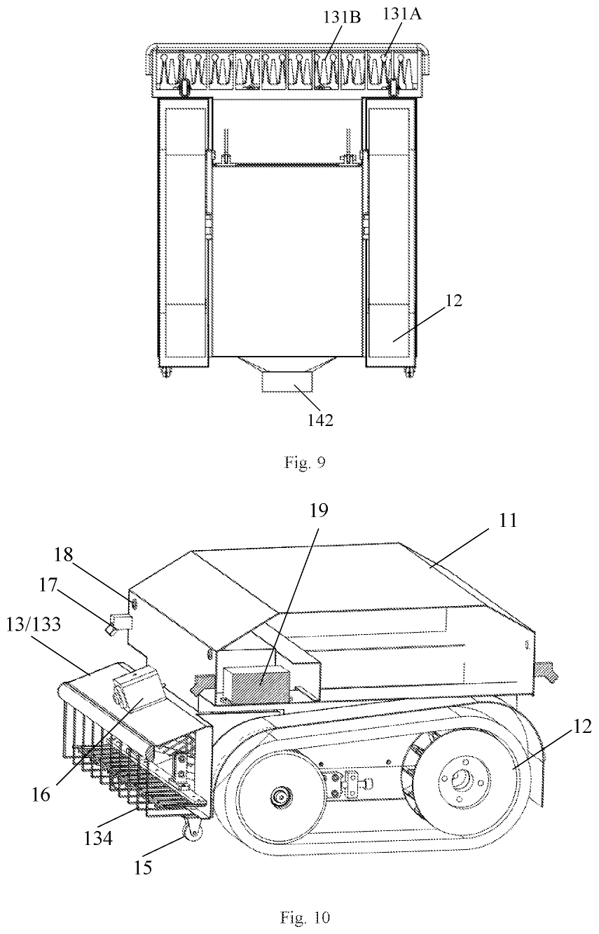

At least one embodiment of the present disclosure provides a mowing robot. FIG. 1 and FIG. 2 are schematic diagrams of a three-dimensional structure of the mowing robot in different directions. FIG. 3 and FIG. 4 are schematic diagrams of a cross-sectional structure of the mowing robot in different directions. FIG. 5 is a schematic diagram of a side structure of the mowing robot. FIG. 6 is a schematic diagram of a front structure of the mowing robot. FIG. 7 is a schematic diagram of a back structure of the mowing robot. FIG. 8 is a schematic diagram of a top structure of the mowing robot. FIG. 9 is a schematic diagram of a bottom structure of the mowing robot. FIG. 10 is another schematic diagram of a cross-sectional structure of the mowing robot.

As shown in FIG. 1 to FIG. 10, the mowing robot includes a body 11, a movement mechanism 12, a cutter assembly 13, a detection sensor and an autonomous navigation module. The movement mechanism 12 is connected to the body 11 and configured to drive the body 11 to move.

For example, the movement mechanism 12 is a crawler track mechanism. For example, the crawler track mechanism includes a wheel set and a crawler track wrapped on the wheel set, so that the crawler track can be driven to move when the wheel set rotates. The crawler track mechanism can better cope with rough roads, improve stability of movement of the mowing robot, and allow the mowing robot to adapt to a more complex mowing environment.

For example, the cutter assembly 13 is arranged in front of the body 11, and includes at least two layers of blades 131 arranged in a stacked manner and a driving mechanism 132 for driving the at least two layers of blades 131. For example, the cutter assembly further includes a top protective cover 133 arranged above the at least two layers of blades 131. The driving mechanism 132 is configured to drive the at least two layers of blades 131 to perform reciprocating relative movement to cut grass.

For example, each layer of blades 131 may use a strip-shaped blade. The width of the strip-shaped blade may be basically equal to the width of the top protective cover 133, so that the blades 131 can mow grass in a larger range. For example, the mowing width is basically equal to the width of the mowing robot, so that the grass located at the edge of obstacles (such as buildings, walls, etc.) can be mowed, mowing efficiency and mowing comprehensiveness can be improved, and the occurrence of missed mowing can be prevented.

For example, the top protective cover 133 may be in a planar shape to shield above the blades 131, so as to protect the blades 131.

It should be noted that, in the embodiments of the present disclosure, the front of a structure refers to the front of the forward/traveling direction of the mowing robot. For example, the front of the body 11 refers to the direction facing the grass to be mowed. For example, in FIG. 1, the forward direction of the mowing robot is the left, and the front of the body 11 refers to the left direction of the body 11. The rear of a structure refers to the direction opposite to the front.

For example, in some embodiments, the at least two layers of blades 131 include two layers of blades or more layers of blades. For example, as shown in FIG. 9, in the embodiment, the at least two layers of blades 131 include an upper blade 131A and a lower blade 131B. Each of the upper blade 131A and the lower blade 131B includes a plurality of cutter teeth. The driving mechanism 132 drives the upper blade 131A to perform left-to-right reciprocating movement and the lower blade 131B to perform right-to-left reciprocating movement, or drives the upper blade 131A to perform right-to-left reciprocating movement and the lower blade 131B to perform left-to-right reciprocating movement, so that the cutter teeth of the upper blade 131A and the lower blade 32 can cooperate with each other to perform a scissor-like trimming action, so as to cut grass. For example, the driving mechanism 132 may be a driving apparatus such as a motor, and the specific form of the driving mechanism 132 is not limited in the embodiments of the present disclosure.

For example, in some embodiments, as shown in FIG. 1 and FIG. 3, the cutter assembly 13 further includes a protective grid 134 arranged in front of and below the at least two layers of blades 131, and the protective grid 134 includes a plurality of grid bars arranged in parallel with each other. For example, the extension direction of the plurality of grid bars is the same as the movement direction of the mowing robot to correspond to the extension direction of grass, so that when the protective grid 134 is in contact with grass, the grass can enter the gaps between the plurality of grid bars along the plurality of grid bars. In this way, the plurality of grid bars can comb and guide the grass while protecting the cutter, so as to facilitate the grass to travel to the blades 131.

For example, in some embodiments, each grid bar of the protective grid 134 is generally L-shaped, as shown in FIG. 1 and FIG. 3. In other embodiments, each grid bar of the protective grid 134 may also be arc-shaped, thus making use of the protective grid 134 for grass entry, climbing and obstacle avoidance.

For example, the detection sensor is configured to detect an environment in which the mowing robot is located and obtain detection data. For example, in some embodiments, the detection sensor may include a sensor such as a visual navigation obstacle avoidance mechanism 16 and a range sensor 18, used to obtain detection data such as whether there is an obstacle in the environment in which the mowing robot is located and the distance from the obstacle, so as to facilitate feedback to the autonomous navigation module to achieve traveling path planning.

For example, the autonomous navigation module is in communication with the detection sensor and configured to plan the traveling path of the mowing robot according to the detection data. For example, the autonomous navigation module may also plan the traveling path of the mowing robot according to preset information (such as pre-stored map information, pre-detected map information or pre-planned area information, etc.). For example, the traveling path may also be adjusted when encountering obstacles, so that the mowing robot can move along the traveling path, thus achieving the effect of automatic mowing. For example, the autonomous navigation module may be provided at the position indicated by reference numeral 19 or other suitable positions, as shown in FIG. 10.

For example, in some embodiments, the autonomous navigation module may further include a Global Navigation Satellite System (GNSS) module. The Global Navigation Satellite System (GNSS) module may obtain real-time position information of the mowing robot. In this case, the autonomous navigation module may be configured to plan the traveling path of the mowing robot according to the detection data and the real-time position information obtained by the Global Navigation Satellite System (GNSS) module.

For example, in some embodiments, the autonomous navigation module may further include an Inertial Measurement Unit (IMU). The inertial measurement unit may detect and measure the motion state of the mowing robot, such as acceleration, inclination, impact, vibration, rotation and multi-degree-of-freedom motion, etc. In this case, the autonomous navigation module may be configured to plan the traveling path of the mowing robot according to the detection data and the motion state of the mowing robot obtained by the inertial measurement unit. Alternatively, the autonomous navigation module may be configured to plan the traveling path of the mowing robot according to the detection data, the real-time position information obtained by the Global Navigation Satellite System (GNSS) module and the motion state of the mowing robot obtained by the inertial measurement unit.

For example, in some embodiments, as shown in FIG. 1 to FIG. 9, the mowing robot may further include a grass collecting apparatus 14. The grass collecting apparatus 14 is arranged in the body 11 and located behind the cutter assembly 13, and is configured to collect grass cut by the cutter assembly 13, and for example, can also collect fallen leaves.

For example, in some embodiments, as shown in FIG. 3 and FIG. 4, the grass collecting apparatus 14 includes a grass inlet 141 and a roller brush 140 that is arranged at a position of the grass inlet 141, and the roller brush 140 is configured to brush grass to the grass collecting apparatus 14. For example, in the examples shown in FIG. 3 and FIG. 4, the roller brush 140 may be configured to move counterclockwise to promote the grass cut by the cutter assembly 13 to enter the grass collecting apparatus 14 along the grass inlet.

For example, in the embodiment shown in FIG. 3 and FIG. 4, the grass inlet 141 is located above the roller brush 140. The grass cut by the cutter assembly 13 is brushed to the grass inlet 141 by the roller brush 140 and then falls into the grass collecting apparatus 14. This arrangement can ensure that the grass collecting apparatus 14 can contain enough grass and prevent the grass from gathering at the bottom of the grass collecting apparatus 14.

For example, in some embodiments, the roller brush 140 includes a roller and a plurality of rows of comb teeth connected to the roller, and six rows of comb teeth are shown as an example in FIG. 3 and FIG. 4. For example, the roller brush 140 may further include a driving motor (not shown in the figure) for driving the roller to rotate, so that the plurality of rows of comb teeth can rotate in a certain direction and at a certain speed.

For example, in some embodiments, as shown in FIG. 2 to FIG. 5, the grass collecting apparatus 14 further includes a grass outlet 142 arranged at a side away from the cutter assembly 13. For example, in a process that the mowing robot mows grass, the grass outlet 142 may be in a closed state. When the mowing robot mows grass completely or more grass in the grass collecting apparatus 14 needs to be discharged, the grass outlet 142 may be in an open state to discharge the grass collected in the grass collecting apparatus 14, which will be described in detail later.

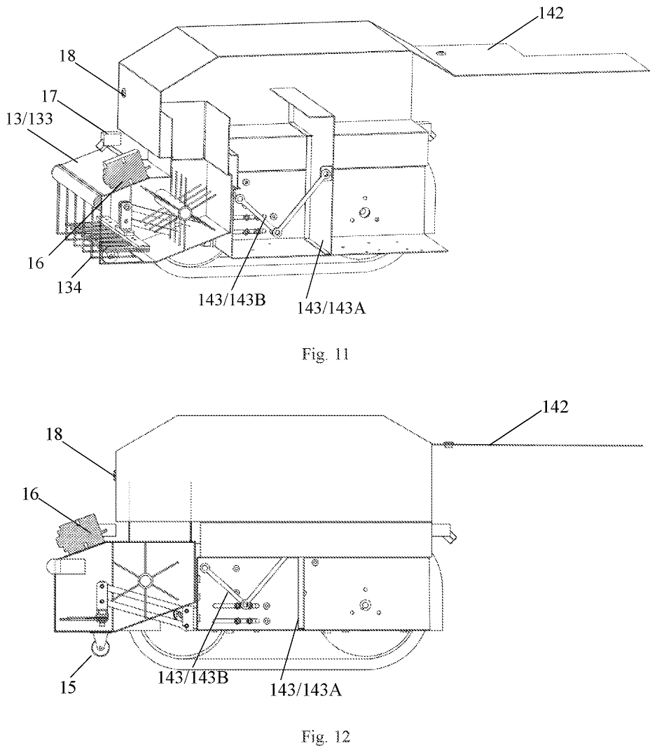

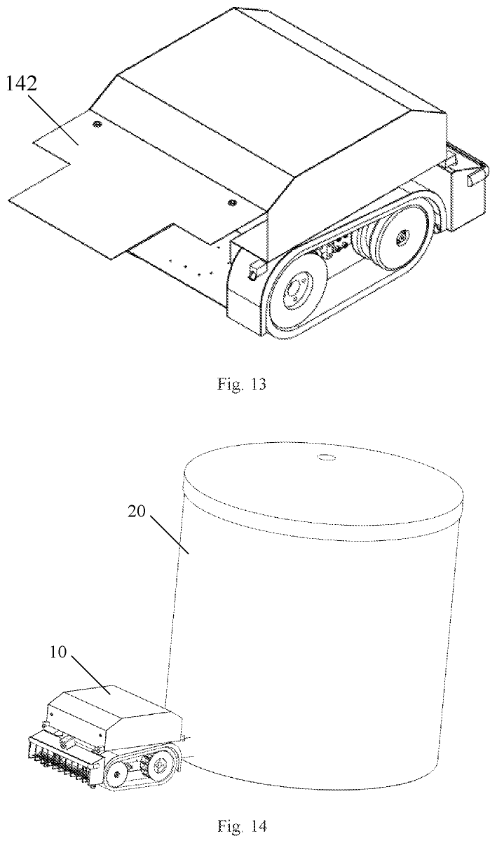

For example, in other embodiments, FIG. 11 and FIG. 12 are schematic diagrams of a cross-sectional structure of another mowing robot, in different directions, according to at least one embodiment of the present disclosure. FIG. 13 is a schematic diagram of a rear structure of a mowing robot. As shown in FIG. 11 to FIG. 13, the grass collecting apparatus 14 further includes a compression apparatus 143. The compression apparatus 143 is configured to compress the grass collected in the grass collecting apparatus 14 and discharge the compressed grass from the grass outlet 142.

For example, the compression apparatus 143 may be a screw compression apparatus, a baffle compression apparatus, or the like. As shown in FIG. 11 and FIG. 12, in the embodiment, the compression apparatus 143 may include a baffle 143A, a support rod 143B for pushing the baffle 143A to move, and a driving motor (not shown in the figure) for driving the support rod 143B to extend or retract. The driving motor can drive the support rod 143B to move the baffle 143A in a direction close to the grass outlet 142 or away from the grass outlet 142, so as to achieve the purpose of compressing the grass collected in the grass collecting apparatus 14.

For example, in the embodiment, the area of the grass outlet 142 is large, for example, the area of the grass outlet 142 is the same as the cross-sectional area of the compressed grass, so that after the grass is compressed, the grass may be easily discharged, for example, to a predetermined grass collection place or a grass storage box by opening the grass outlet 142.

For example, in some embodiments, the mowing robot may further include a first lifting driving mechanism. The first lifting driving mechanism is connected to the cutter assembly 13 and configured to drive the cutter assembly 13 to perform lifting and lowering, that is, the first lifting driving mechanism can drive the entire cutter assembly 13 including the top protective cover 133, the blades 131 and the protective grid 134 to perform lifting and lowering. For example, when it is detected that there is an obstacle in front of the mowing robot, the first lifting driving mechanism can drive the entire cutter assembly 13 to rise to avoid the obstacle. For example, the first lifting driving mechanism may be a lifting and lowering driving motor.

For example, in some embodiments, the first lifting drive mechanism includes a lifting and lowering distance detection module. The lifting and lowering distance detection module is configured to detect the lifting or lowering distance of the cutter assembly 13. For example, the lifting and lowering distance detection module may be a distance sensor, which obtains the lifting or lowering distance of the cutter assembly 13 by detecting the distance between the cutter assembly 13 and a certain part of the body 11. Alternatively, the lifting and lowering distance detection module may also obtain the lifting or lowering distance of the cutter assembly 13 by detecting the rotating direction and the number of revolutions/rotations of the lifting driving motor. Alternatively, the lifting and lowering distance detection module may also detect the distance between the cutter assembly 13 and a certain part of the body 11 through a photoelectric sensor, a Hall sensor or the like. The embodiments of the present disclosure do not limit the specific form of the lifting and lowering distance detection module.

For example, in some embodiments, the mowing robot may further include a second lifting driving mechanism. The second lifting driving mechanism is connected to the at least two layers of blades 131 and configured to drive the at least two layers of blades 131 to perform lifting and lowering.

For example, as shown in FIG. 4, the second lifting driving mechanism is a blade driving mechanism 134. The blade driving mechanism 134 may drive the blade 131 to lifting and lowering in the space defined by the top protective cover 133 and the protective grid 134 to control the height of the blade 131 in the cutter assembly 13. For example, the blade driving mechanism 134 includes a driving motor and a support arm driven by the driving motor. Two ends of the support arm are connected to the driving motor and the blade 131, respectively, thereby achieving the driving function.

For example, in some embodiments, the top protective cover 133, the protective grid 134 and the blade 131 may be made of metal or alloy materials, such as aluminum or aluminum alloy, stainless steel, etc., so as to have high strength and corrosion resistance. The roller and comb teeth of the roller brush may also be made of metal or alloy materials, such as aluminum or aluminum alloy, stainless steel, etc., so as to have high strength and avoid being pressed and deformed by heavy grass.

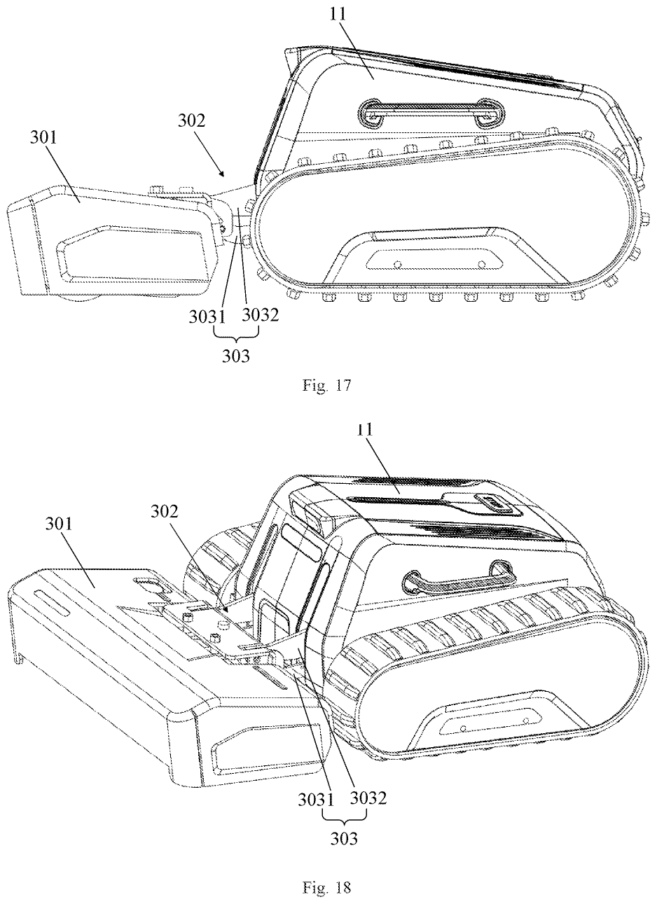

For example, FIG. 17 to FIG. 20 are schematic diagrams of a structure of another mowing robot according to at least one embodiment of the present disclosure. In some embodiments, as shown in FIG. 17 to FIG. 20, the mowing robot may further include a cutter holder 301 and an overturning apparatus 302. The cutter assembly 13 is connected to the cutter holder 301. The overturning apparatus 302 includes a connecting rod assembly 303. The connecting rod assembly 303 is connected between the body 11 and the cutter holder 301 and configured to be controlled in an initial state or an overturned state to drive the cutter holder 301 in an initial state or an overturned state.

For example, the overturning apparatus 302 may further include an overturning motor. The overturning motor is located, for example, in the body, which is not shown in the figure. The overturning motor can drive the cutter assembly 13 to achieve state conversion.

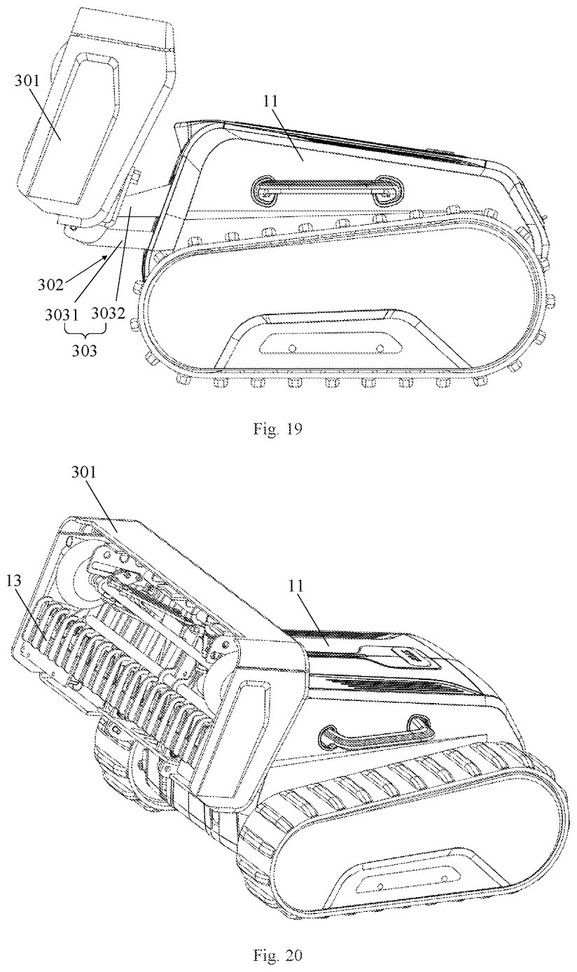

For example, as shown in FIG. 17 to FIG. 20, the connecting rod assembly 303 may include a first connecting rod 3031 (e.g., two first connecting rods 3031 arranged symmetrically) and a second connecting rod 3032 (e.g., two second connecting rods 3032 arranged symmetrically). The first connecting rod 3031 and the second connecting rod 3032 are connected to different positions of the cutter holder 301, respectively. The first connecting rod 3031 and the second connecting rod 3032 are configured to be controlled to perform extension or retraction actions to drive the cutter holder 301 to be in the initial state (as shown in FIG. 17 and FIG. 18) or the overturned state (as shown in FIG. 19 and FIG. 20), respectively.

For example, as shown in FIG. 17 to FIG. 20, compared with the ground, the first connecting rod 3031 is in a lower position and the second connecting rod 3032 is in a higher position, that is, the second connecting rod 3032 is higher than the first connecting rod 3031. In this case, compared with the initial state, the overturning motor controls the first connecting rod 3031 to extend and the second connecting rod 3032 to retract, so as to control the cutter holder 301 to change from the initial state to the overturned state.

In the embodiments of the present disclosure, as shown in FIG. 20, the cutter holder 301 is overturned, so that the cutter assembly 13 may be fully exposed, thereby facilitating the cleaning and maintenance of the cutter assembly 13, and also facilitating the assembly and disassembly of the cutter assembly 13, so as to improve the convenience of use of the cutter assembly 13.

For example, in some embodiments, the connecting rod assembly 303 may be further configured to be controlled to perform lifting and lowering to drive the cutter holder 301 to perform lifting and lowering, so as to achieve the effect of adjusting the height of the cutter holder 301. For example, the lifting and lowering action of the connecting rod assembly 303 may also be achieved by the overturning motor. In this case, the cutter holder 301 can perform lifting and lowering motion and overturning motion simultaneously. For example, during operation, the cutter holder 301 may be lifted to a certain height and then overturned, thus facilitating different users to maintain the cutter assembly 13. In this case, the overturning apparatus 302 can achieve the function of the first lifting driving mechanism and may be used as an example of the first lifting driving mechanism.

For example, in some embodiments, as shown in FIG. 1 and FIG. 4 to FIG. 6, the mowing robot may further include a wheel set apparatus 15. The wheel set apparatus 15 includes at least one rolling wheel. The rolling wheel is connected in front of and/or below the cutter assembly 13 to keep the distance between the cutter assembly 13 and a target object (such as a bottom surface or an obstacle), thereby protecting the cutter assembly 13.

For example, in some embodiments, as shown in FIG. 1, the wheel set apparatus 15 includes two rolling wheels. The two rolling wheels are arranged on opposite sides of the cutter assembly 13, respectively, and the figure shows that the two rolling wheels are arranged on opposite sides below the cutter assembly 13, so that the wheel set apparatus 15 can roll along the ground or the surface of an obstacle when the mowing robot moves to the undulating ground or encounters an obstacle. The protective grid 134 of the cutter assembly 13 is prevented from rubbing against the ground or the obstacle, thereby achieving the effect of protecting the cutter assembly 13 and avoiding the obstacle.

For example, in some embodiments, as shown in FIG. 1, the visual navigation obstacle avoidance mechanism 16 is arranged in front of and/or behind the body 11 and configured to detect whether there is an obstacle in the environment in which the mowing robot is located.

For example, the number of the visual navigation obstacle avoidance mechanism 16 may be one or more. For example, a visual navigation obstacle avoidance mechanism 16 may be provided in front of the body 11, and a visual navigation obstacle avoidance mechanism 16 may be provided behind the body 11, so as to facilitate obstacle avoidance identification in front of and behind the body 11.

For example, in some embodiments, the visual navigation obstacle avoidance mechanism 16 may use a monocular or binocular camera apparatus, and identify whether there is an obstacle in the environment in which the mowing robot is located and feed it back to the autonomous navigation module of the mowing robot, so that the autonomous navigation module re-plans the traveling path of the mowing robot to achieve the obstacle avoidance function.

For example, in some embodiments, as shown in FIG. 1, in order to further improve the safety of the mowing robot, the mowing robot may further include a collision detection mechanism 17. The collision detection mechanism 17 is configured to determine whether a collision occurs by detecting displacement or deformation of the top protective cover 133, the protective grid 134, the blade 131 or the driving mechanism 132 or detecting the current or voltage of the driving mechanism 132.

For example, in some embodiments, the collision detection mechanism 17 may use various apparatuses that can detect displacement or deformation, such as a distance sensor, a mechanical switch, a photoelectric infrared diode pair, a Hall sensor, and the like, so as to determine whether a collision occurs by detecting whether the above apparatuses are displaced. Alternatively, the collision detection mechanism 17 may use a current/voltage detection apparatus, so as to determine whether the driving mechanism 132 is blocked by detecting whether the current or voltage of the driving mechanism 132 is too large, and then determine whether a collision occurs.

For example, the number of the collision detection mechanism 17 may be one or more, as shown in FIG. 1 and FIG. 2. In the embodiment, the number of the collision detection mechanism 17 is four. The four collision detection mechanisms 17 are arranged at four corners in front of and behind the body 11, respectively, so as to facilitate the collision detection operation at the four corners of the body 11.

For example, in some embodiments, as shown in FIG. 1, the range sensor 18 is arranged on the body 11 and configured to detect a distance between the mowing robot and the target object (such as a wall, a building, etc.), so as to determine whether the mowing robot reaches a target place or meets an obstacle. Furthermore, the range sensor 18 can feed back a measurement result to the autonomous navigation module of the mowing robot, so as to facilitate the autonomous navigation module to re-plan the route and perform other operations.

For example, the range sensor 18 may be a millimeter wave sensor, a lidar sensor, an ultrasonic sensor, a binocular camera, or the like.

For example, the number of the range sensor 18 may be one or more, as shown in FIG. 1 and FIG. 2. In the embodiment, the number of the range sensor 18 is four. The four range sensors 18 are arranged at four corners in front of and behind the body 11, respectively, so as to facilitate the ranging operation at the four corners of the body 11.

For example, in some embodiments, the mowing robot may further include a controller (not shown in the figure). The controller is in communication with the movement mechanism 12, the visual navigation obstacle avoidance mechanism 16, the collision detection mechanism 17, the range sensor 18, the first lifting driving mechanism and the second lifting driving mechanism, the autonomous navigation module, and the like (for example, communication in a wired or wireless manner), and is configured to comprehensively achieve the automatic moving and mowing operation of the mowing robot. For example, the controller is configured to control the first lifting driving mechanism to drive the cutter assembly 13 to rise to protect the cutter assembly 13 when the collision detection mechanism 17 detects a collision. For example, the controller may also control the second lifting driving mechanism to adjust the height of the blade 131 to mow grass at a predetermined height. For example, when the range sensor 18 detects that the mowing robot is too close to a target object (such as a wall or a building) in a certain direction or the visual navigation obstacle avoidance mechanism 16 detects that there is an obstacle in front of the mowing robot, the autonomous navigation module re-plans the traveling path of the mowing robot to avoid the target object. The controller controls the movement mechanism 12 to change the traveling path. For example, the controller may also achieve other functions in addition to those described above, so as to achieve the automatic operation of the mowing robot, which will not be described in detail here.

In the mowing robot according to the embodiments of the present disclosure, the grass collecting apparatus 14 can fully collect the grass cut by the cutter assembly 13 while the cutter assembly 13 mows the grass, so as to achieve a cleaner mowing environment while mowing the grass, and avoid manual work such as harvesting the grass after mowing, thereby improving working efficiency and reducing labor costs. On the other hand, the mowing robot is provided with various intelligent detection and management modules, such as the visual navigation obstacle avoidance mechanism 16, the collision detection mechanism 17 and the range sensor 18, which can achieve the automatic and unmanned mowing operation and has high safety.

For example, in other embodiments, the mowing robot may further include a grass shredding apparatus (not shown in the figure) instead of a grass collecting apparatus. The grass shredding apparatus is arranged in the body 11 and located behind the cutter assembly 13 (such as the position of the grass collecting apparatus 14 in FIG. 1) and configured to receive and shred the grass cut by the cutter assembly 13. In this case, the grass cut by the cutter assembly 13 may be shredded by the grass shredding apparatus and evenly scattered on the ground.

For example, in some embodiments, the grass shredding apparatus may include a motor and a rotating blade connected to the motor. The rotating blade rotates to shred the grass under the drive of the motor.

Alternatively, in other embodiments, the mowing robot may be provided with both a grass collecting apparatus and a grass shredding apparatus. The grass shredding apparatus may be arranged in the grass collecting apparatus, so as to shred the grass collected in the grass collecting apparatus and facilitate grass recycling.

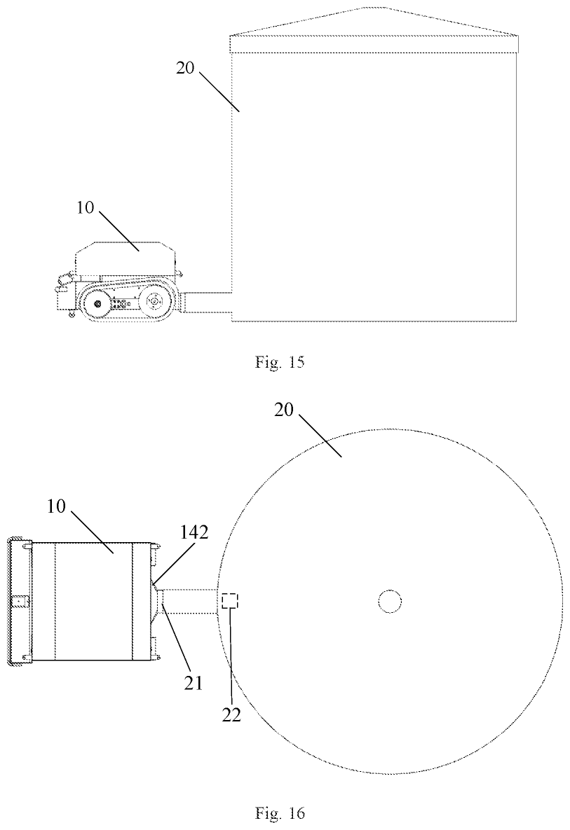

At least one embodiment of the present disclosure further provides a grass mowing and collecting device. FIG. 14 is a schematic diagram of a three-dimensional structure of the grass mowing and collecting device. FIG. 15 is a schematic diagram of a side structure of the grass mowing and collecting device. FIG. 16 is a schematic diagram of a top structure of the grass mowing and collecting device. As shown in FIG. 14 to FIG. 16, the grass mowing and collecting device includes the mowing robot 10 according to the embodiments of the present disclosure and a grass storage box 20. The mowing robot 10 includes a grass collecting apparatus 14 (refer to FIG. 1 to FIG. 10). The grass storage box 20 includes a grass inlet 201. The grass inlet is configured to be connected to the grass outlet 142 of the grass collecting apparatus 14 to receive the grass in the grass collecting apparatus.

For example, in some embodiments, the grass storage box 20 may passively receive grass in the grass collecting apparatus 14. For example, when the mowing robot includes a compressing apparatus 143, the support rod 143B of the compressing apparatus can directly push the compressed grass into the grass storage box 20 or a predetermined place.

For example, in other embodiments, the grass storage box 20 may actively receive the grass in the grass collecting apparatus 14.

For example, the grass storage box 20 further includes a suction apparatus 202 arranged at the grass inlet 201. The grass inlet 201 is configured to be connected to the grass outlet 142 of the grass collecting apparatus 14, so that the suction apparatus 202 can suck grass from the grass collecting apparatus 14 into the grass storage box 20 through the grass outlet 142 and the grass inlet 201, thereby recycling the grass collected in the grass collecting apparatus 14 to the grass storage box 20 for treatment.

For example, the suction apparatus 202 may be an apparatus with a suction function such as a vacuum cleaner, and the embodiments of the present disclosure do not limit the specific form of the suction apparatus 202.

For example, during the use of the grass mowing and collecting device, the grass storage box 20 may be provided at a predetermined place, such as a charging position of the mowing robot. After completing the mowing operation along a predetermined path, the mowing robot can automatically return to the predetermined place and align the grass outlet 142 of the grass collecting apparatus 14 with the grass inlet 201 of the grass storage box 20. In this case, the suction apparatus 202 is turned on to recycle the grass from the grass collecting apparatus 14 to the grass storage box 20.

For example, in some embodiments, a gravity sensing apparatus, such as a gravity sensor, may be arranged at the bottom of the grass collecting apparatus 14. When the gravity sensing apparatus detects that the gravity it bears reaches a certain value, it is inferred that the grass collecting apparatus 14 is full of grass. Alternatively, the top or side wall of the grass collecting apparatus 14 may be provided with an infrared sensing apparatus or a distance sensing apparatus. When the infrared sensing apparatus or the distance sensing apparatus detects that the grass reaches a certain height, it is inferred that the grass collecting apparatus 14 is full of grass. In this case, the controller of the mowing robot can control the mowing robot to return to the predetermined place, align the grass outlet 142 of the grass collecting apparatus 14 with the grass inlet 201 of the grass storage box 20, and turn on the suction apparatus 202 to recycle the grass from the grass collecting apparatus 14 to the grass storage box 20.

To sum up, the mowing robot according to the embodiments of the present disclosure uses a crawler track mechanism, which may better cope with rugged roads. The cutter of the mowing robot is arranged in front of the body, which can cut the grass at corners to mow grass in all directions. On the one hand, the cutter is equipped with a protective apparatus to form a hidden cutter, thereby improving safety of the cutter, achieving protection of the cutter and prolonging the service life of the cutter. On the other hand, the mowing robot is further provided with a detection sensor, an autonomous navigation module and a controller, which can automatically control the working state of the mowing robot to adapt to the complex mowing environment, improve mowing efficiency and safety, and reduce labor costs.

The grass mowing and collecting device according to the embodiments of the present disclosure can collect the grass cut by the mowing robot into the grass storage box 20, and therefore there is no need to clean the mowing area again, achieving the integration of grass mowing and recycling, improving working efficiency and reducing labor costs.

The following statements should be noted:
(1) The drawings involve only the structure(s) in connection with the embodiment(s) of the present disclosure, and other structure(s) can be referred to common design(s).
(2) For clarity, in the drawings used to describe the embodiments of the present disclosure, the thicknesses of layers or regions are enlarged or reduced, that is, the drawings are not drawn to actual scale.
(3) In case of no conflict, features in one embodiment or in different embodiments can be combined to obtain new embodiments.

What have been described above are only specific implementations of the present disclosure, the protection scope of the present disclosure is not limited thereto, and the protection scope of the present disclosure should be based on the protection scope of the claims.

1. A mowing robot, comprising:
a body,
a movement mechanism, connected to the body and configured to drive the body to move, wherein the movement mechanism is a crawler track mechanism,
a cutter assembly, arranged in front of the body and comprising a blade to cut grass,
a detection sensor, configured to detect an environment in which the mowing robot is located and obtain detection data, and
an autonomous navigation module, configured to plan a traveling path of the mowing robot according to the detection data.

2. The mowing robot according to claim 1, wherein the cutter assembly further comprises a top protective cover arranged above the blade.

3. The mowing robot according to claim 2, wherein the cutter assembly further comprises a protective grid arranged in front of and below the blade, and the protective grid comprises a plurality of grid bars arranged in parallel.

4. The mowing robot according to claim 1, further comprising:
a grass collecting apparatus, arranged in the body and located behind the cutter assembly, and configured to collect grass cut by the cutter assembly.

5. The mowing robot according to claim 4, wherein the grass collecting apparatus comprises a grass inlet and a roller brush arranged at a position of the grass inlet, and the roller brush is configured to brush grass to the grass collecting apparatus.

6. The mowing robot according to claim 4, wherein the grass collecting apparatus further comprises a grass outlet at a side away from the cutter assembly.

7. The mowing robot according to claim 6, wherein the grass collecting apparatus further comprises a compression apparatus, wherein the compression apparatus is configured to compress the grass collected in the grass collecting apparatus and discharge compressed grass from the grass outlet.

8. The mowing robot according to claim 1, further comprising:
a first lifting driving mechanism, connected to the cutter assembly and configured to drive the cutter assembly to perform lifting and lowering.

9. The mowing robot according to claim 1, further comprising:
a second lifting driving mechanism, connected to the blade and configured to drive the blade to perform lifting and lowering.

10. The mowing robot according to claim 1, further comprising:
a wheel set apparatus, comprising at least one rolling wheel connected in front of and/or below the cutter assembly to keep a distance between the cutter assembly and a target object.

11. The mowing robot according to claim 1, further comprising:
a cutter holder, wherein the cutter assembly is connected to the cutter holder, and
an overturning apparatus, comprising a connecting rod assembly, wherein the connecting rod assembly is connected between the body and the cutter holder and configured to be controlled in an initial state or an overturned state to drive the cutter holder in an initial state or an overturned state.

12. The mowing robot according to claim 11, wherein the connecting rod assembly comprises a first connecting rod and a second connecting rod, the first connecting rod and the second connecting rod are respectively connected to different positions of the cutter holder,
the first connecting rod and the second connecting rod are respectively configured to be controlled to perform extension or retraction actions to drive the cutter holder to be in the initial state or the overturned state.

13. The mowing robot according to claim 11, wherein the connecting rod assembly is further configured to be controlled to perform lifting and lowering to drive the cutter holder to perform lifting and lowering.

14. The mowing robot according to claim 1, wherein the detection sensor comprises:
a visual navigation obstacle avoidance mechanism, arranged in front of and/or behind the body and configured to detect whether there is an obstacle in an environment in which the mowing robot is located.

15. The mowing robot according to claim 14, wherein the detection sensor further comprises:
a range sensor, arranged on the body and configured to detect a distance between the mowing robot and a target object.

16. The mowing robot according to claim 1, further comprising:
a grass shredding apparatus, arranged in the body and located behind the cutter assembly, and configured to receive and shred the grass cut by the cutter assembly.

17. A grass mowing and collecting device, comprising:
the mowing robot according to claim 1, wherein the mowing robot comprises a grass collecting apparatus, and
a grass storage box, comprising a grass inlet, wherein the grass inlet is configured to be connected to a grass outlet of the grass collecting apparatus to receive the grass in the grass collecting apparatus.

18. The grass mowing and collecting device according to claim 17, wherein the grass storage box further comprises a suction apparatus arranged at the grass inlet, so that the suction apparatus is able to suck grass from the grass collection apparatus into the grass storage box through the grass outlet and the grass inlet.

19. The grass mowing and collecting device according to claim 1, wherein the cutter assembly comprises at least two layers of blades arranged in a stacked manner and a driving mechanism for driving the at least two layers of blades, the driving mechanism is configured to drive the at least two layers of blades to perform reciprocating relative movement, to cut grass
